(19) United States
(12) Patent Application Publication
(10) Pub. No.: US 2005/0289175 A1
(43) Pub. Date: Dec. 29, 2005

(54) Providing XML node identity based operations in a value based SQL system

(75) Inventors: Muralidhar Krishnaprasad, Fremont, CA (US); Zhen Hua Liu, San Mateo, CA (US); Vikas Arora, San Francisco, CA (US); James W. Warner, Mountain View, CA (US); Anand Manikutty, Foster City, CA (US)

Correspondence Address: HICKMAN PALERMO TRUONG & BECKER/ORACLE, 2055 GATEWAY PLACE, SUITE 550, SAN JOSE, CA, 95110-1089, US

(73) Assignee: ORACLE INTERNATIONAL CORPORATION, REDWOOD SHORES, CA (US)

(21) Appl. No.: 11/100,083

(22) Filed: Apr. 5, 2005

Related U.S. Application Data
(60) Provisional application No. 60/599,319, filed on Aug. 6, 2004.
(60) Provisional application No. 60/582,706, filed on Jun. 23, 2004.

(51) Int. Cl. G06F 17/00

(52) U.S. Cl. 707/102

(57) ABSTRACT

Object-relational database systems process XML values in a way that preserves node identities of nodes in the XML values and perform node-id based operations more efficiently or even in circumstances where such operations were not performed. An object-relational database system represents an XML value as a serialized stream of bytes, herein referred to as a serialized image. A serialized image may represent an XML value of the XMLType that is stored and/or generated by an object-relational database system. The serialized image contains one or more node identifiers that identify nodes within the XML value. The serialized image may also contain a pointer to an in-memory representation of the XML value, allowing the in-memory representation to be accessed via the pointer without having re-create the in-memory representation.

### RELATED APPLICATIONS

This application claims priority to U.S. Provisional Application No. 60/599,319, Efficient Evaluation of Queries Using Translation, filed on Aug. 6, 2005 by Zhen Hua Liu, et. el., the contents of which are incorporated herein by reference.

This application claims priority to U.S. Provisional Application No. 60/582,706, Efficient Evaluation of Queries Using Translation, filed on Aug. 6, 2005 by Zhen Hua Liu, et. el., the contents of which are incorporated herein by reference.

This application is related to U.S. patent application Ser. No. 10/428,878, entitled Techniques For Rewriting XML Queries Directed To Relational Database Constructs, filed by Anand Manikutty, et al. on May 1, 2003, referred to hereafter as the “Rewrite Application”, the contents of which are incorporated herein by reference as if originally set forth herein.

This application is related to U.S. patent application Ser. No. 10/428,393, entitled Techniques For Transferring A Serialized Image Of XML Data, filed by Muralidhar Krishnaprasad, et al. on May 1, 2003, referred to hereafter as the “Serialization application”, the contents of which are incorporated herein by reference as if originally set forth herein.

### FIELD OF THE INVENTION

The present invention relates to accessing and evaluating structured information stored in databases and more specifically to techniques for efficiently and evaluating XML data.

### BACKGROUND OF THE INVENTION

The Extensible Markup Language (XML) is the standard for data and documents that is finding wide acceptance in the computer industry. XML describes and provides structure to a body of data, such as a file or data packet, referred to herein as an XML entity. The XML standard provides for tags that delimit sections of an XML entity referred to as XML elements. Each XML element may contain one or more name-value pairs referred to as attributes. The following XML Segment A is provided to illustrate XML.

SEGMENT A

<book>My book

<publication publisher=“Doubleday”

date=“January”></publication>

<Author>Mark Berry</Author>
<Author>Jane Murray</Author>

</book>

XML elements are delimited by a start tag and a corresponding end tag. For example, segment A contains the start tag <Author> and the end tag </Author> to delimit an element. The data between the elements is referred to as the element's content. In the case of this element, the content of the element is the text data Mark Berry.

An element is herein referred to by its start tag. For example, the element delimited by the start and end tags <publication> and </publicat ion> is referred to as element <publication>.

Element content may contain various other types of data, which include attributes and other elements. The <book> element is an example of an element that contains one or more elements. Specifically, <book> contains two elements: <publication> and <author>. An element that is contained by another element is referred to as a descendant of that element. Thus, elements <publication> and <author> are descendants of element <book>. An element's attributes are also referred to as being contained by the element.

By defining an element that contains attributes and descendant elements, the XML entity defines a hierarchical tree relationship between the element, its descendant elements, and its attribute. A set of elements that have such a hierarchical tree relationship is referred to herein as an XML document.

The term XML value is used herein to refer to any value stored or represented by an XML document or parts thereof. An XML value may be a scalar value, such as the string value of an element and the numeric value of an attribute-value pair; an XML value may be a set of values, such as a subtree of elements within an element, or an XML document.

Node Tree Model

An important standard for XML is the XQuery 1.0 and XPath 2.0 Data Model. (see W3C Working Draft 9 Jul. 2004, which is incorporated herein by reference) One aspect of this model is that an XML value is represented by a hierarchy of nodes that reflects the hierarchical nature of an XML value. A hierarchy of nodes is composed of nodes at multiple levels. The nodes at each level are each linked to one or more nodes at a different level. Each node at a level below the top level is a child node of one or more of the parent nodes at the level above. Nodes at the same level are sibling nodes. In a tree hierarchy or node tree, each child node has only one parent node, but a parent node may have multiple child nodes. In a tree hierarchy, a node that has no parent node linked to it is the root node, and a node that has no child nodes linked to it is a leaf node. A tree hierarchy has a single root node.

In a node tree that represents an XML document, a node can correspond to an element, the child nodes of the node correspond to an attribute or another element contained in the element. The node may be associated with a name and value. For example, for a node tree representing the element <book>, the name of the node associated with element <book> is book, and the value is ‘My book’. For a node representing the attribute publisher, the name of the node is publisher and the value of the node is ‘Doubleday’.

For convenience of expression, elements and other parts of an XML document are referred to as nodes within a tree of nodes that represents the document. Thus, referring to ‘My book’ as the value of the node with name book is just a convenient way of expressing the value of the element associated with node book is My book.

An important notion of the XQuery 1.0 and XPath 2.0 Data Model is that a node is unique. Each node has a unique identity. Every node is identical to itself but not identical to any other node. On the other hand, atomic values do not have identity; every instance of the integer value ‘5’ integer is identical to every other instance integer value ‘5’.

FIG. 1 depicts a node tree 101 used to illustrate node identity. Node tree 101 includes root node A, and descedant nodes B, C, and D. Node B has the value 5, node C the value ‘a’, and node D the value 5. Eventhough node B and node D have the same value 5, node B and node D are not identical. Node B is identical to node B but not node D, and vice versa.

XML Storage Mechanisms

Various types of storage mechanisms are used to store an XML document. One type of storage mechanism stores an XML document as a text file in a file system.

Another type of storage mechanism uses object-relational database systems that have been enhanced to store and query XML values. In an embodiment, an XML document is stored in a row of a table and nodes of the XML document are stored in separate columns in the row. An entire XML document may also be stored in a lob (large object). An XML document may also be stored as a hierarchy of objects in an object-relational database; each object is an instance of an object class and stores one or more elements of an XML document. The object class defines, for example, the structure corresponding to an element, and includes references or pointers to objects representing the immediate descendants of the element. Tables and/or objects of a database system that hold XML values are referred to herein as base tables or objects.

Another enhancement made to relational database systems to support storage and processing of XML is the XML value type referred to as XML type. XML type is defined by the SQL/XML standard (see INCITS/ISO/IEC 9075-14:2003, which is incorporated herein by reference). An object-relational database system may support XMLType as a native built-in data type representing XML values just as any other native data type, such as VARCHAR, the name of an SQL data type representing variable length character values. The term XML value refers to any value represented by the XQuery Data Model. The XQuery Data Model is described in XQuery 1.0 and Xpath2.0 Data Model, W3C Working Draft, 29 Oct. 2004, which is incorporated herein by reference. Object-relational database systems use XMLType to represent XML values in very diversified situations. For example, XMLType instances can be XML documents natively stored in XMLType tables or XMLType columns of tables. The XMLType instances can be generated from relational tables and views using SQL/XML publishing functions, such as XMLElement( ) and XMLAgg( ). XMLType instances can be generated from the result of an XQuery embedded in an XMLQuery( ) function or XMLTable construct. XMLType instances can be generated from the result of an XPath embedded in an extract( ) function. XMLType instances can be the return type of a user defined or system defined function. An XMLType instance can be converted from an object type, collection type or an arbitrary user defined opaque type in an object-relational database system.

Object-Relational database systems that support XML as a native built-in data type use the XML type to type datan in many diversified situations. For example, the XML value can be used to define XML documents natively stored in XML tables or XML columns in tables. The XML value can be generated from sources defined by SQL data types (e.g. relational tables and views) using the SQL/XML publishing functions, such as XMLElement( ) and XMLAgg( ). The XML value can be generated from the result of an XQuery query embedded in the XMLQuery( ) function or the XMLTable construct. The XML value can refer to XML documents from an integrated XML repository. An XML value can also be the result of a user defined or system defined SQL function or expression.

XML Query Operations Supported by Object-Relational Database

It is important for object-relational database systems that store XML values to be able to execute queries using XML query languages, such as XQuery/XPath. XML Query Language (“XQuery”) and XML Path Language (“XPath”) are important standards for a query language, which can be used in conjunction with SQL to express a large variety of useful queries. XPath is described in XML Path Language (XPath), version 1.0 (W3C Recommendation 16 Nov. 1999), which is incorporated herein by reference. XPath 2.0 and XQuery 1.0 are described in XQuery 1.0 and XPath 2.0 Full-Text. (W3C Working Draft 9 Jul. 2004), which is incorporated herein by reference.

XPath/XQuery defines important operations that depend on tracking node identities. These operations include node navigation, node identity checking, and node ordering. Such operations are referred to herein as node-id based operations. For example, consider the following XQuery query:

for $i in doc(“Po.xml”)/PurchaseOrder
where $i/ShippingAddress <<
$i/ReceivingAddress
return $i

The ‘<<’ operator in the WHERE clause compares nodes referenced by the operator's operands. The operator evaluates to TRUE if the node on the left is present before the node on the right in the original XML document. Knowing the identity of nodes allow such evaluations to be made.

Handling of node-id based operations by an object-relational database system is problematic. Problems stem from the fact that an object-relational database system's execution of relational queries is performed using value-based operations. Relational queries are queries that conform to a database language for accessing object-relational data constructs, such as tables, columns, and views. An example of such a language is SQL. Value-based operations are operations that return copies of values but not the identity of the source of those values. When a value-based operation generates a copy of an XML value, the identity of the node's value is not returned or preserved. Node id based operations between such XML values cannot be performed.

Based on the foregoing, there is a need for an object-relational database system to generate XML values in a way the preserves node identities to allow node-id operations to be performed.

Functional Evaluation

In object-relational database systems that support XQuery/XPath, an XQuery/XPath operation can be carried out using functional evaluation. Functional evaluation entails using an in-memory representation of an XML value to perform the XQuery/XPath operation. The XML document's base table is accessed to retrieve the data needed to form the in-memory representation.

To perform a functional evaluation, the in-memory representation such as a DOM representation, must be generated. The process of generating an in-memory representation of an XML document is referred to herein as materialization. The in-memory representation has a tree-node structure that reflects the hierarchy of the XML value. The in-memory representation often comprises groups or collections of interlinked data structures or objects that individually represent a node and that collectively represent an XML value. For convenience of expression, such data structures are also referred to together as a hierarchy or tree of nodes and individually as a node.

The following query QE1 is provided as an example.

select

extract(po,‘/PurchaseOrder/Pono’).

from po_table;

Query QE1 invokes the SQL Extract function, and returns the node identified by the XPath string ‘/PurchaseOrder/Pono’. To perform a functional evaluation, the data for an XML document is retrieved from the base table po_table, and the in-memory representation of the XML document is generated and evaluated to return the node identified by the XPath string.
   Inefficiencies Attendant to Functional Evaluation

Functional evaluation is performed in a way that wastes memory and processing power. When evaluating a query, an in-memory representation may be generated for the same XML document many times, as illustrated by the following query QE4.

select

extract(po,‘/PurchaseOrder/Pono’),
extract(extract(po,‘/PurchaseOrder/ShippingAddress’)
, ‘//City’),
extract(po,‘/PurchaseOrder/BillingAddress’), . . .

from po_table;

Each row in base table po_table corresponds to an XML document. For each such document, the generation of an in-memory representation of the XML document is repeated for each of the Extract function invocations in query QE4.

Such wastefulness is aggravated by several other factors. For example, when an in-memory representation is generated on a computer different than that of the object-relational database system that stores the base table of an XML document, the values in the base table for the whole XML document are transmitted for each functional evaluation of the XML document. Thus, in the case of query QE4, each time the in-memory representation is generated for an XML document, its values from the base table are transmitted over a network.

Based on the foregoing, there is a need for a more efficient approach for performing functional evaluation.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram depicting a node tree according to an embodiment of the present invention.

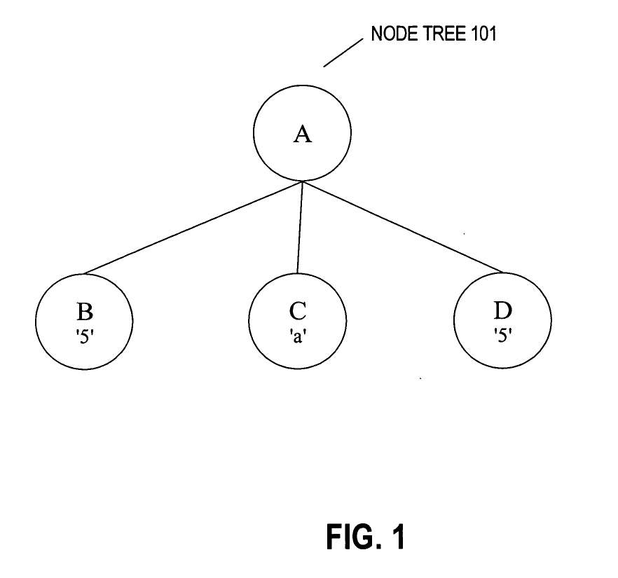

FIG. 2 is a block diagram that illustrates a serialized image with node identifiers according to an embodiment of the present invention.

FIG. 3 is a block diagram that illustrates a serialized image with node identifiers according to an embodiment of the present invention.

FIG. 4 is a diagram illustrating how functional analysis of multiple expressions may reuse the same in-memory representation of an XML value.

FIG. 5 is a block diagram of a computer system used to illustrate an embodiment of the present invention.

### DETAILED DESCRIPTION OF THE INVENTION

A method and apparatus is described for performing node identity based operations in a value based system. According to an embodiment of this invention, multiple functional evaluations can also be optimized. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Described herein are approaches that represent XML values as a serialized stream referred to herein as a serialized image. The serialized images are generated so that they contain one or more identifiers that identify nodes. The identifiers can be used to perform node-id based operations. According to another aspect of the approaches, object-relational database systems perform functional evaluations for a query without having to re-materialize a particular XML value multiple times.

Using Node Identifiers to Perform Node-id Operations During Query Rewrite

Node-id operations can be performed during a process for executing XQuery/XPath queries referred to herein as a query rewrite or “rewrite”. During rewrites, XQuery/XPath queries received by an object-relational database system are dynamically rewritten into object-relational queries that directly reference and access the underlying base tables. Specific techniques for implementing the rewrite approach are described in the Rewrite application.

During execution of the rewritten queries, XML values are generated and represented as a serialized image. The serialized images may represent XML values returned as query results of the rewritten query, or may represent intermediate XML values generated to evaluate the query, such as those generated for a subquery or other types of expressions, such as a nested Extract function or the operand of an operator in a WHERE clause expression.

According to an embodiment, a serialized image for an XML value may include node identifiers that identify, for a particular node of the XML value, the row and column (i.e. cell) in a base table that holds the node's value. Many object-relational database systems associate a unique row-id for each row in a table and a unique column-id for each column in the table. Thus, for a given node among the nodes of an XML value stored in a row of a table, the combination of the row-id and column-id for the node should be different than the combination for another node stored in a different column with a different column id. In an embodiment, a column can also be an attribute accessor. (e.g. ShippingAddress.Street)

A row and column may hold more than one node of an XML value. In this case, a node identifier may also include information about a node's position within a hierarchy of an XML value. For example, the node identifier may specify that the given node is the third node in an element.

Such information about a node's position within a hierarchy may be discerned by examining metadata maintained by an object-relational database system to define data types, including data types for XML values. Such metadata can take the form of an XML schema that conforms to the standard XML Schema. XML Schemas are XML documents that contain information about the structure of specific types of XML documents. A format and standard for an XML schema is XML Schema, Part 0, Part 1, Part 2, W3C Recommendation, 2 May 2001, the contents of which are incorporated herein by reference. Such metadata is generated by an object-relational database system in response to receiving database definition language (“DDL”) commands.

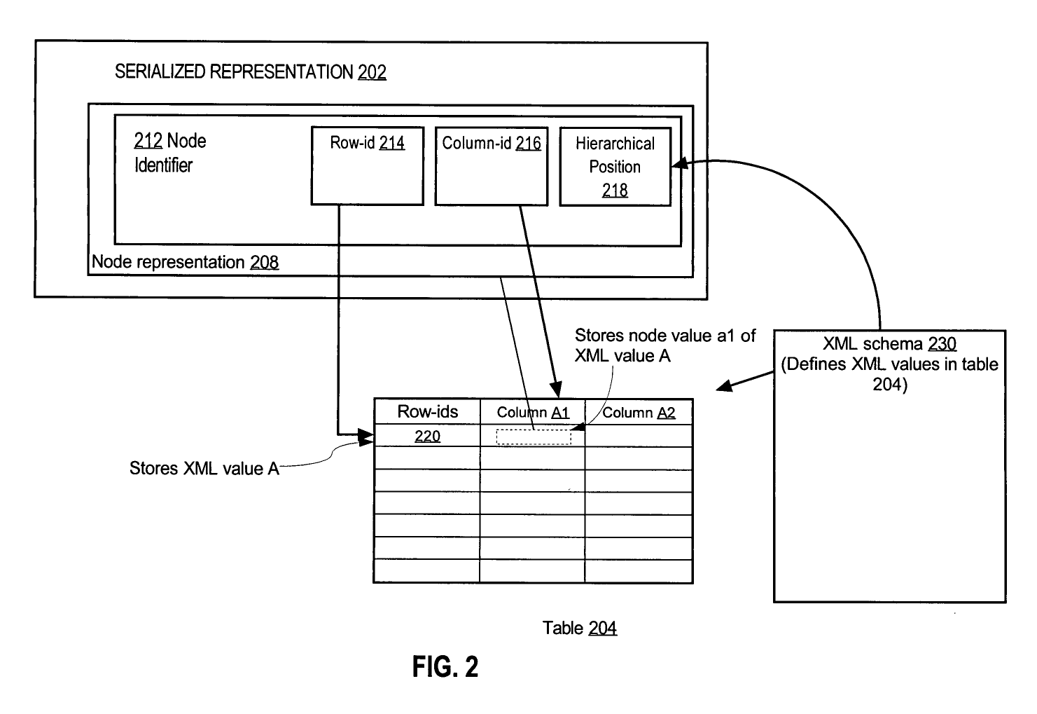

FIG. 2 is a block diagram that shows a serialized image with a node identifier according to an embodiment of the present invention. Referring to FIG. 2, it shows serialized image 202, which is a serialized image of an XML value A. XML value A is stored in table 204. FIG. 2 shows column A1 and column A2 of table 204 and shows a row-id pseudo-column. The row with row-id 220 holds XML value A.

For purposes of exposition, various features of serialized image 201 are not shown. Further details of illustrative serialized images that may be used in an embodiment are described in the Serialization application. The Serialization application describes such features as a payload, which holds a serialized representation of an XML value, and flags, which indicate the form and format of a serialized image and payload.

Serialized image 202 includes a node representation 208, which is the portion of serialized image 202 that represents a node a1 of XML value A. The value of node a1 is stored in row 220 and column A1. Typically, a serialized image for an XML value contains multiple such node representations. For purposes of exposition, only one is shown.

Node representation 208 includes node identifier 212, which includes row-id 214, column-id 216, and hierarchical position 218. Row-id 214 is data that identifies row 220, data such as a row-id; column-id 216 is data that identifies column A1, data such as a column-id.

Hierarchical position 218 is hierarchical position data, which is data that indicates the hierarchical position of a node within an XML value. Hierarchical position 218 indicates node a1's position within the hierarchy of an XML value A. Hierarchical position 218 is generated based on XML schema 230, of which XML value A1 is an instance. XML schema 230 is part of the metadata maintained by an object-relational database system. In another embodiment, hierarchical position 218 may be generated from metadata maintained by an object-relational database system to define object types for objects that hold XML values.

Finally, serialized image 202 may contain or be associated with one or more flags that indicate the particular form or format of serialized image 202. The value of the flags identifies the format and version of the format. A set of flag values may identify a format that includes node identifiers. Another set of flag values may identify other formats that do not include node identifiers, such as the flag values described in the Serialized application.

The node identifiers in XML values are used to perform node-id based operations during execution of rewritten query without having to perform a functional evaluation, and/or without having to generate a complete or partial in-memory representation of an XML value. For example, to determine whether a node represented by a serialized image is the same as that represented by another serialized representation, the respective node identifiers in the serialized images may be compared. If the row-id, column-id, and hierarchical position data of the node identifiers match, then the nodes are the same.

Approaches described herein enable node-id based operations to be performed in a value-based system. Furthermore, such operations may be performed by an object-relational database system, enabling a system that has knowledge about how the XML values are stored in the base table to optimize such operations. Using the object-relational database to perform node-id based operations allows them to be performed “closer” to the data. Data transfer through a network to an application is minimized.

Serialized Images with Pointers Used for Node-id Operations and to Reuse In-Memory Representations

According to an embodiment of the present invention, serialized images are generated with pointers. The serialized images not only allow node-id based operations to be performed more efficiently but also allow functional evaluations to avoid regenerating in-memory representations of the same XML values.

The term pointer, as used herein, is data that specifies the location of a data structure that is in memory or is stored persistently or transiently on disk. Examples of pointers include a memory pointer or handle. Illustrative techniques for generating serialized images that contain pointers are described in the Serialization application.

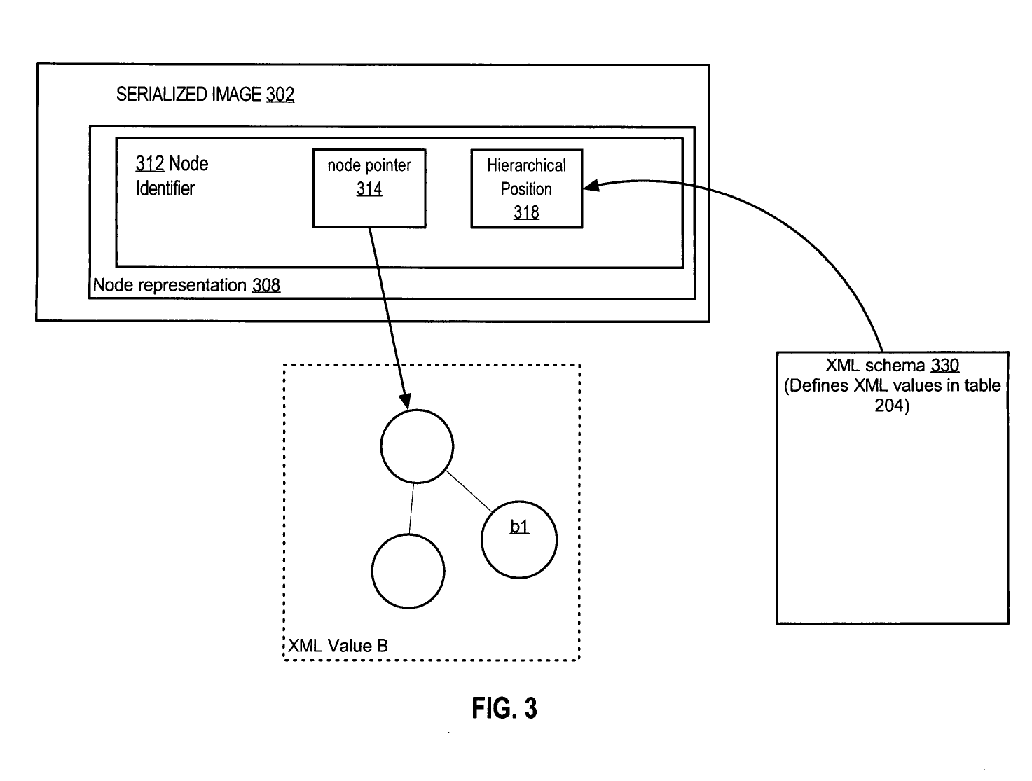

FIG. 3 shows serialized image 302. Serialized image 302 includes a node representation 308, which is the portion of serialized image 302 that represents a node b1 of an XML value B. As mentioned before, a serialized image for an XML value may contain multiple such node representations; but for purposes of exposition, only one is shown.

Node representation 308 includes node identifier 312, which includes node pointer 314 and hierarchical position 318. Node pointer 314 is a pointer to an in-memory representation that contains node b 1. Hierarchical position 318 is data that indicates node b1's position within the hierarchy of XML value B. Hierarchical position 318 can be generated based on XML schema 330, of which XML value B is an instance. XML schema 330 is part of the metadata maintained by an object-relational database system. In another embodiment, hierarchical position 318 may be generated from metadata maintained by an object-relational database system to define object types for objects that hold XML values.

Finally, serialized image 302 may contain or be associated with one or more flags that indicate the particular form or format of serialized image 302. The value of the flags identifies the format and version of the format. A set of flag values may identify a format that includes node identifiers. Another set of flag values may identify other formats that do not include node identifiers, such as the flag values described in the Serialized application. The Serialized application in fact describes formats that use pointers that point to XML values. In an embodiment of the present invention, for a serialized image of an XML value, each node identifier of a node in the serialized image may include (1) a pointer to the node in an in-memory representation, (2) hierarchical position data and a pointer to an ancestor node of the node, the combination of which may be used to identify or locate the node, or (3) just hierarchical position data, which when combined with a pointer to an ascendant of the node stored in the serialized image, may be used to identify or locate the node.

Using a Pointer to Perform Node-Id Based Operation

Node identifiers with a pointer provide an efficient means to perform node-id based operations. The following XQuery XQ1 is used to illustrate how a serialized image with a pointer as a node identifier may be used to efficiently perform node-id based operations.

select xmlquery(‘let $i := <A><B>44</B></A> ,

$j := $i/B
return $j/ . . . is $i‘

returning content) from dual;

Query XQ1 specifies to construct an XML value for node <A>, a node identity traversal operation to node B, and a determination of whether the result of the traversal operation is same as the parent in the XML value. To execute query XQ1, an in-memory representation and serialized image is generated for <A>. The serialized image has a pointer to the in-memory representation. The serialized image is returned as the value for $i. The path operation for B performs a node-id based traversal operation, using the pointer in the serialized image to access the already generated serialized image, and returning, as a result of the operation, a serialized image with a pointer to the node for <B> in the in-memory representation. In evaluating the expression $j/ . . . is $i, the respective serialized images are evaluated. From the pointers within the serialized images, and evaluation of the in-memory representation pointed to by the pointers, it can be determined that the result of the expression is TRUE, since the pointer of the parent of $j is the same as $i.

Other Forms of Node Identifiers

According to an embodiment, a node identifier may include an object id, such as an object id generated by an object-relational database system to uniquely identify an object instance. It should be understood that the present invention is not limited to any particular form of a node identifier.

Also, a node identifier need not by itself identify a node. Rather, a node identifier may have to be combined with other information to identify a node. For example, when a node identifier may include a pointer, for checking equality, it may be sufficient to check only the pointers. If the pointers are the same, then the nodes pointed to by them are the same. However, multiple pointers might still point to the same node. Also, for determining order, the nodes pointed to by the pointer may be examined. To determine whether a node in a pair of serialized images are the same or for performing order related operations, the respective pointers contained in a serialized image may be used to get the referenced in-memory representation, which can then be examined to make the determination.

Using Serialized Images with Pointers to Avoid Regeneration of In-Memory Representations

As mentioned earlier, when executing a query that entails operations that require materialization of the same XML value, such as the evaluation of Extract functions, the XML value is materialized once for one operation. Subsequent operations that require materialization of the XML value can use the already generated in-memory representation. The operation that materializes the XML value generates and/or returns a serialized image with a pointer to the in-memory representation. The serialized image with a pointer is passed to a subsequent operation requiring the in-memory representation, which uses the pointer in the serialized image to access the in-memory representation of the materialized XML value.

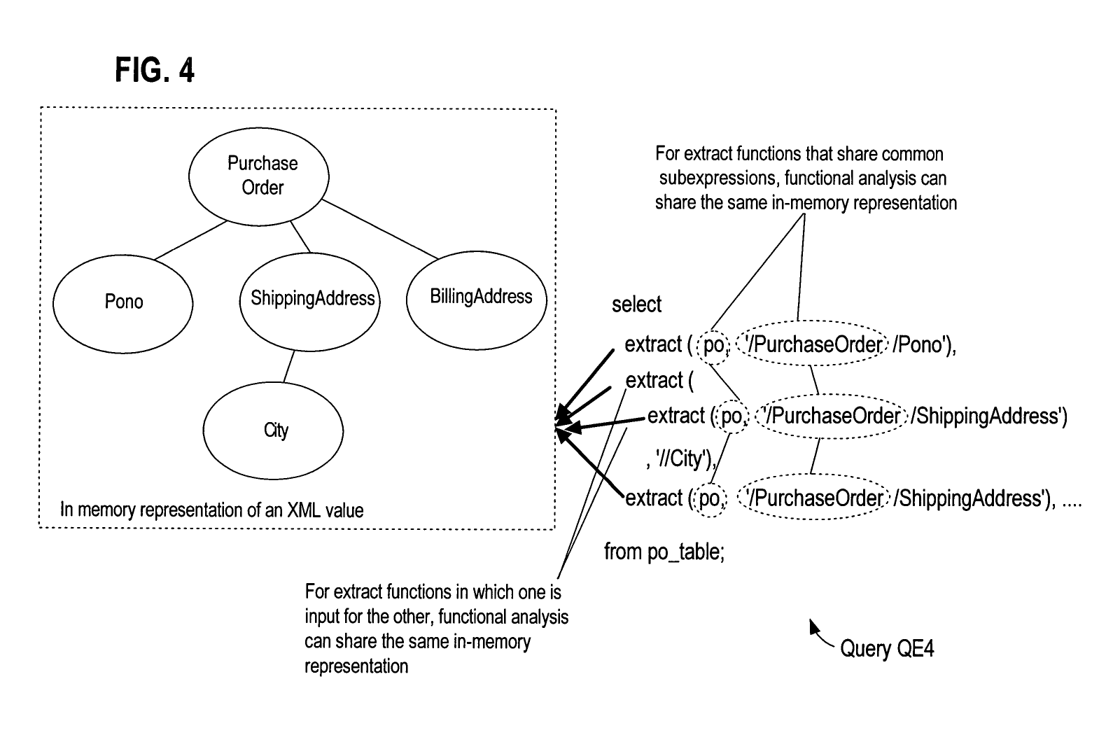

FIG. 4 shows a query QE4, which is used to illustrate how an in-memory representation of an XML value generated during evaluation of a query can be shared by the functional analysis of multiple expressions within the query. First, a database system performs a compile-time analysis of query QE4. Compile-time analysis refers to the process of determining what operations, resources, and/or data structures are required to evaluate a query. In performing a compile-time analysis of query QE4, the database system analyzes various expressions in query QE4.

An expression is a component of a computer language that identifies a value or defines the computation of a value. Query QE4 contains various expressions. In QE4, the components extract (po, ‘/PurchaseOrder/Pono’) and extract (po, ‘/PurchaseOrder/BillingAddress’) are expressions in the form of function invocations. The component extract(extract(po, ‘/PurchaseOrder/ShippingAddress’), ‘//City’) is a function invocation within a function invocation, where one function is an input parameter of the other. The XPath string ‘/PurchaseOrder/ShippingAddress’ is also an expression, because it is a string value, one which also identifies a node.

The term ‘SQL expression’ refers to an expression that can be used in an SQL query or SQL procedural languages that are used to write user defined functions and procedures. Examples of SQL expressions are table or view columns, arithmetic functions, logical functions, SQL case functions, SQL/XML publishing functions, XMLQuery( ) functions, extract( ) functions, PL/SQL variables, etc. The expressions within query QE4 are also examples of SQL expressions.

A subexpression is an expression within an expression. In the function invocation extract (po, ‘/PurchaseOrder/Pono’), po and ‘/PurchaseOrder/Pono’ are subexpressions. Within the XPath string ‘/PurchaseOrder/Pono’, ‘/PurchaseOrder’ is a subexpression.

Compile-time analysis of query QE4 determines that functional evaluation of the various invocations of the Extract function can be performed using the same in-memory representation of the same XML value. This determination is made in several ways.

First, compile-time analysis determines that three Extract function invocations have input parameters with common subexpressions, i.e. po and ‘/PurchaseOrder’. Thus, compile-time analysis determines that the in-memory representation of an XML value generated during an evaluation of one of these Extract function invocations may be used by subsequent evaluations of the Extract function invocations. When an evaluation produces a serialized image containing a pointer to an in-memory representation, the serialized image is passed to or made available to subsequent evaluations that can use the in-memory representation. During these evaluations, the pointer in the serialized image is used to access the in-memory representation.

Second, compile-time analysis determines that one of the Extract functions is an input for another Extract function, and therefore determines that the in-memory representation of an XML value generated during the evaluation of the input Extract function may be used during the evaluation of the other. The serialized image generated as the value of the input Extraction function is passed to or made available to the evaluation of the other Extract function, during which the pointer in the serialized image is used to access the in-memory representation.

Reference Counting

Eventually, an in-memory representation is no longer needed and storage of it in memory is no longer required. To determine when an in-memory representation may be removed from memory, a reference counter is used. Specifically, when an in-memory representation is generated, a pointer to the in-memory representation is created and a reference counter for the pointer is incremented by 1. When another operation that requires access to the in-memory representation creates another reference to the in-memory representation, the pointer counter is incremented by 1 again. When the memory for the pointer is de-allocated (or deleted), the reference counter is decremented by 1. Those in-memory representations with zero value reference counters may can be deleted from memory.

Hardware Overview

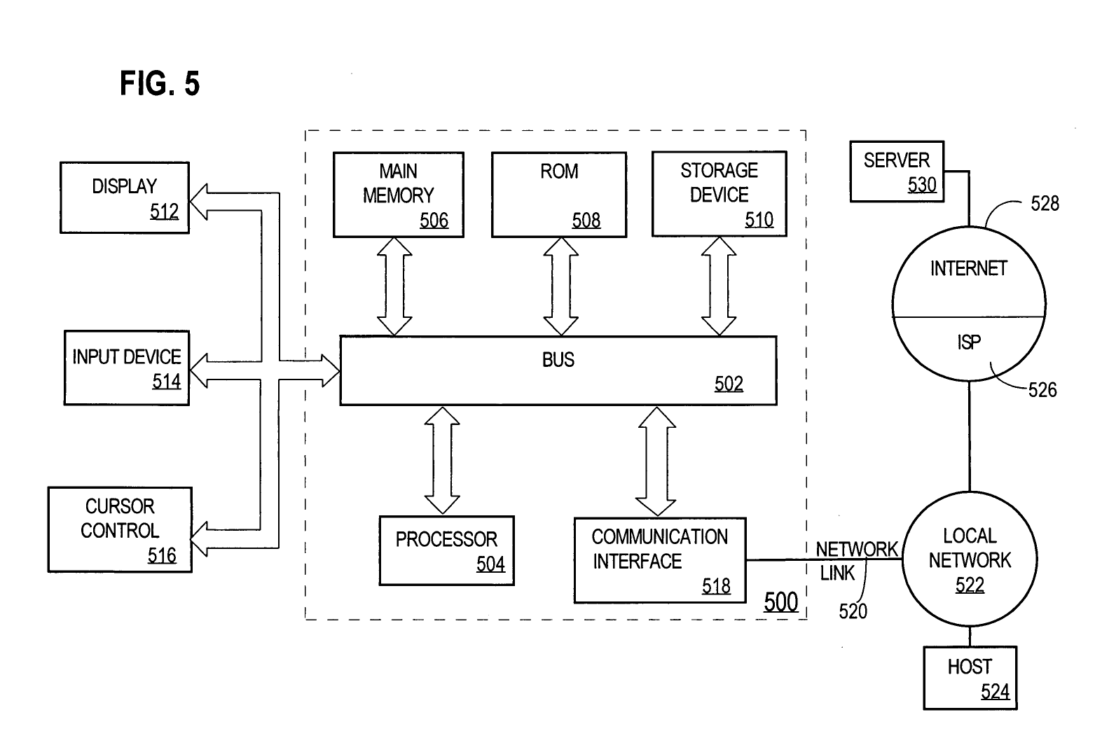

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing instructions to processor 504 for execution. Such a medium may take many forms, including but not limited to, non-volatile media, volatile media, and transmission media. Non-volatile median includes, for example, optical or magnetic disks, such as storage device 510. Volatile median includes dynamic memory, such as main memory 506. Transmission median includes coaxial cables, copper wire and fiber optics, including the wires that comprise bus 502. Transmission media can also take the form of acoustic or light waves, such as those generated during radio-wave and infra-red data communications.

Common forms of machine-readable median include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method for generating a representation of an XML value type, comprising the steps of:
for each XML value of a plurality of XML values, generating a serialized image;
wherein each XML value includes at least one node, each node of said at least one node having a node value; and
within each serialized image generated for each XML value of said plurality of XML values, storing a node identifier that uniquely identifies said at least one node relative to any other node in the plurality of XML values.

2. The method of claim 1, wherein:
the plurality of XML values include a first XML value and a second XML value;
a first serialized image is generated for the first XML value and a second serialized image is generated for the second XML value; and
the steps further include the step of performing a node-id based operation by comparing the node identifier of the first serialized image to the node identifier of the second serialized image

3. The method of claim 2, wherein
the node identifier of the first serialized image includes first hierarchical position data;
the node identifier of the second serialized image includes second hierarchical position data; and
the step of comparing the node identifier of the first serialized image to the node identifier of the second serialized image includes comparing the first hierarchical position data to the second hierarchical position data.

4. The method of claim 3, wherein:
for each XML value of said plurality of XML values, said each XML value is an instance of an XML schema; and
the first hierarchical position data and the second hierarchical position data includes data based on said XML schema.

5. The method of claim 2, wherein
an in-memory is generated for the first serialized image;
an in-memory representation is generated for the second serialized image;
the step of performing a node-id based operation includes comparing the respective in-memory representations of the first serialized image and the second serialized image.

6. The method of claim 1, wherein the node identifier includes a pointer.

7. The method of claim 1, wherein for each XML value of said plurality of XML values, the value for the at least one node is stored in a column of a table in an object-relational database system.

8. The method of claim 7, wherein the node-identifier includes data identifying a row in said table.

9. The method of claim 8, wherein the node identifier includes data identifying said column.

10. A computer-implemented method, the method comprising the steps of:
a database system receiving a database query that includes a first expression and a second expression that returns one or more XML values;
wherein an evaluation of the second expression requires access to an in-memory structure representing an XML value;
during an evaluation of the first expression, generating the in-memory representation representing the XML value and a pointer to the in-memory representation; and
during an evaluation of the second expression, accessing the in-memory representation using the pointer.

11. The method of claim 10, the steps further including:
generating a serialized image as an XML value returned for the first expression, wherein said generating a serialized image includes storing a pointer to the in-memory representation in the serialized image; and
wherein accessing the in-memory representation includes accessing the in-memory representation using the pointer from the serialized image.

12. The method of claim 11, wherein the steps further include:
determining that the first expression and the second expression specify a common expression; and
wherein said determining causes accessing the in-memory representation using the pointer from the serialized image during the evaluation of the second expression.

13. The method of claim 12, wherein the step of determining is performed during compile-time analysis of said database query.

14. The method of claim 10, the steps further include:
determining that the second expression is a subexpression of the first expression; and
wherein said determining causes said accessing the in-memory representation using the pointer from the serialized image during the evaluation of the second expression.

15. The method of claim 14, wherein:
the first expression is a function invocation; and
determining that the second expression is a subexpression of the first expression includes determining that the second expression is an input parameter of the function invocation.

16. A computer-implemented method, the method comprising the steps of:
generating an in-memory representation of an XML value in the memory of a computer;
generating a first serialized image of the XML value that contains a first pointer to the in-memory representation; and
generating a second serialized image of the XML value that contains a second pointer to the in-memory representation of the XML value.

17. The method of claim 16, wherein the steps further include performing a node-id based operation based on the first pointer.

18. The method of claim 17, wherein performing a node-id based operation includes comparing the first pointer to the second pointer.

19. The method of claim 17, wherein performing a node-id operation includes evaluating the in-memory representation, wherein evaluating the in-memory representation includes using the first pointer in the serialized image to access the in-memory representation and evaluate the in-memory representation.
